(19) United States
(12) Patent Application Publication
(10) Pub. No.: US 2012/0121343 A1
(43) Pub. Date: May 17, 2012

(54) NOZZLE FOR PROVIDING PARTICULATE MATERIALS TO BULK TRANSFER APPARATUS

(75) Inventors: Paul Kerr, Saskatchewan (CA); Kent Woods, Saskatchewan (CA)

(73) Assignee: REM ENTERPRISES INC., Swift Current, Saskatchewan (CA)

(21) Appl. No.: 13/386,675

(22) PCT Filed: Jun. 29, 2010
(86) PCT No.: PCT/CA2010/001040

§ 371 Date: Jan. 24, 2012

(30) Foreign Application Priority Data
Jul. 27, 2009 (CA) 2673899

(51) Int. Cl. B65G 53/42

(52) U.S. Cl. 406/152

(57) ABSTRACT

A nozzle for providing particulate materials to a suction intake hose connected to a bulk transfer apparatus is provided. A body structure of the nozzle comprises comprising a connecting mechanism for connecting to an end portion of the suction intake hose. A support mechanism is mechanically connected to the body structure for movably supporting the body structure. A particulate materials transport mechanism is placed in front of the body structure. The particulate materials transport mechanism comprises a movable mechanical structure for mechanically transporting the particulate materials into an airstream generated by suction through the suction intake hose. A hood is mounted to a front portion of the body structure for guiding the airstream towards and opening in fluid communication with the connecting mechanism.

### FIELD OF THE INVENTION

The present invention relates to the field of bulk transfer machines for particulate materials, and more particularly to a nozzle for providing particulate materials to a suction intake hose connected to a bulk transfer apparatus.

### BACKGROUND OF THE INVENTION

Pneumatic bulk transfer apparatuses are widely used in agriculture and industry for transferring grain and various other types of particulate materials such as, for example, grain, fertilizer, pellets, etc. Such devices have substantially facilitated the bulk transfer of particulate materials, a previously laborious and time-consuming task accomplished by shoveling. For example, bulk transfer apparatuses are used for transferring grain from a storage facility of a farm to a delivery truck. Typically, an end portion of an intake hose is placed by an operator in close proximity to the particulate materials that are to be transferred, which are rendered airborne by an airstream caused by suction through the intake hose.

To facilitate portability and enable use at different locations, pneumatic bulk transfer apparatuses have been provided as mobile units, for example, mounted on a trailer and powered by a tractor.

Unfortunately, in various applications there is a need for using a long intake hose making it difficult for an operator to handle the end portion of the intake hose, in particular in a confined storage facility. Furthermore, using a long intake hose substantially increases suction loss, thus, the airstream for rendering the particulate materials airborne is reduced causing a substantial reduction in the efficiency of the transfer of the particulate materials. This is of particular concern when mobile units having limited power are employed.

It is desirable to provide a nozzle for being connected to the end portion of the intake hose of a bulk transfer apparatus that is simple and easily maneuverable.

It is also desirable to provide a nozzle for being connected to the end portion of the intake hose of a bulk transfer apparatus that has an improved rate of transfer of particulate materials when suction is weak.

It is also desirable to provide a nozzle that is adapted for providing an active area for receiving particulate material that is significantly wider than the width of the vacuum hose.

### SUMMARY OF THE INVENTION

Accordingly, one object of the present invention is to provide a nozzle for being connected to the end portion of the intake hose of a bulk transfer apparatus that is simple and easily maneuverable.

Another object of the present invention is to provide a nozzle for being connected to the end portion of the intake hose of a bulk transfer apparatus that has an improved rate of transfer of particulate materials when suction is weak.

Another object of the present invention is to provide a nozzle that is adapted for providing an active area for receiving particulate material that is significantly wider than the width of the vacuum hose.

According to one aspect of the present invention, there is provided a nozzle for providing particulate materials to a suction intake hose connected to a bulk transfer apparatus. A body structure of the nozzle comprises a connecting mechanism for connecting to an end portion of the suction intake hose. A support mechanism is mechanically connected to the body structure for movably supporting the nozzle. A particulate materials transport mechanism is placed in front of the body structure. The particulate materials transport mechanism comprises a movable mechanical structure for mechanically transporting the particulate materials into an airstream generated by suction through the suction intake hose. A hood is mounted to a front portion of the body structure for guiding the airstream towards an opening in fluid communication with the connecting mechanism.

According to another aspect of the present invention, there is further provided a nozzle for providing particulate materials to a suction intake hose connected to a bulk transfer apparatus. A body structure of the nozzle comprises a connecting mechanism for connecting to an end portion of the suction intake hose. Two independently rotatable wheels are mounted to a left hand side of the body structure and a right hand side of the body structure in proximity to a rear portion of the body structure. A first drive mechanism and a second drive mechanism drive the first wheel and the second wheel, respectively. The first drive mechanism and the second drive mechanism are capable of simultaneously driving the first wheel in a forward direction and the second wheel in a rearward direction. A particulate materials transport mechanism is placed in front of the body structure. The particulate materials transport mechanism comprises a movable mechanical structure for mechanically transporting the particulate materials into an airstream generated by suction through the suction intake hose. A hood is mounted to a front portion of the body structure for guiding the airstream towards an opening in fluid communication with the connecting mechanism.

The advantage of the present invention is that it provides a nozzle for being connected to the end portion of the intake hose of a bulk transfer apparatus that is simple and easily maneuverable.

A further advantage of the present invention is that it provides a nozzle for being connected to the end portion of the intake hose of a bulk transfer apparatus that has an improved rate of transfer of particulate materials when suction is weak.

A further advantage of the present invention is that it provides a nozzle that is adapted for providing an active area for receiving particulate material that is significantly wider than the width of the vacuum hose.

### BRIEF DESCRIPTION OF THE DRAWINGS

A preferred embodiment of the present invention is described below with reference to the accompanying drawings, in which:

FIG. 1a is a simplified block diagram illustrating a perspective front view of a nozzle according to a preferred embodiment of the invention;

FIG. 1b is a simplified block diagram illustrating a perspective rear view of the nozzle according to a preferred embodiment of the invention;

FIG. 1c is a simplified block diagrams illustrating the perspective front view of the nozzle according to a preferred embodiment of the invention with a plane through the centers of the wheels added;

FIGS. 2a and 2b are simplified block diagrams illustrating a perspective left hand side view and a perspective right hand side view, respectively, of a detail of a nozzle according to another embodiment of the invention;

FIGS. 3a and 3b are simplified block diagrams illustrating front views of nozzles according to yet other embodiments of the invention; and,

FIG. 4 is a simplified block diagram illustrating a perspective rear view of a nozzle according to yet another embodiment of the invention.

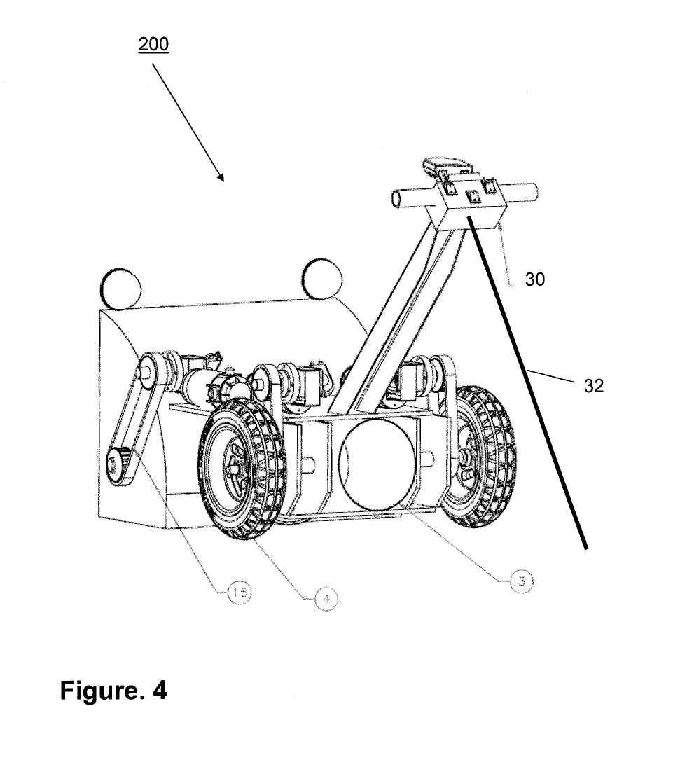

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments herein below is with reference to a nozzle for being connected to the end portion of the intake hose of a portable bulk transfer apparatus used in agriculture for transferring grain, it will become evident to those skilled in the art that the embodiments of the invention are not limited thereto, but are also applicable for being connected to a stationary bulk transfer apparatus as well as be used for transfer of various particulate materials in agriculture and industry.

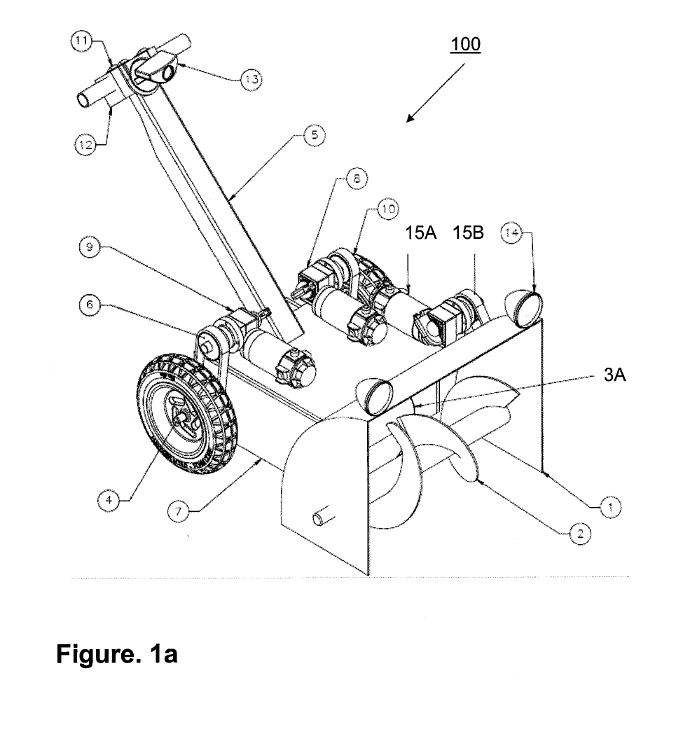

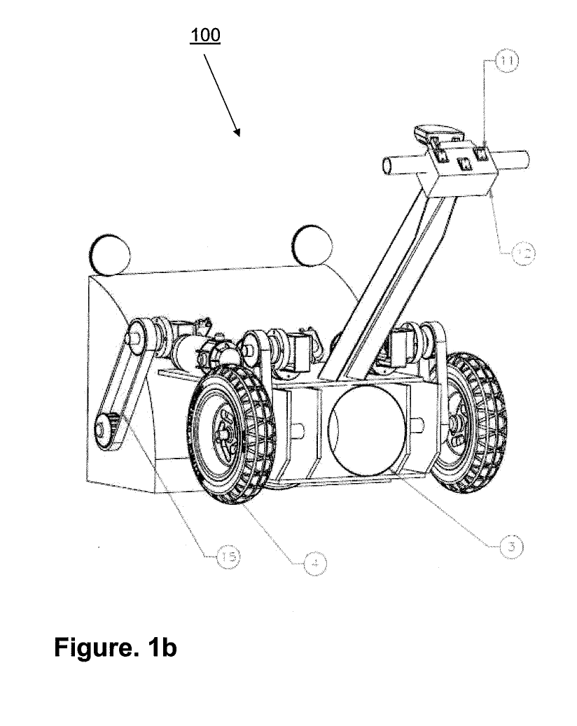

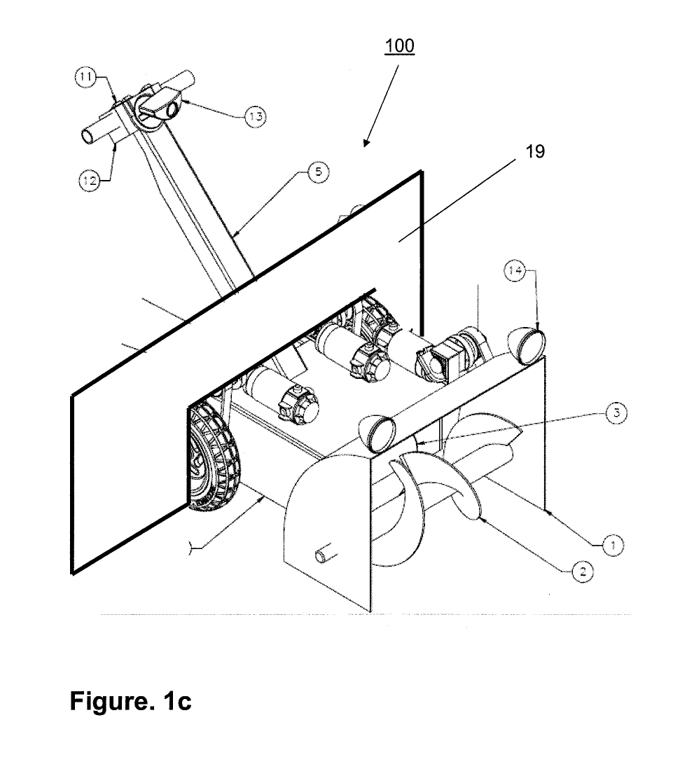

Referring to FIGS. 1a to 1c, a nozzle 100 for providing particulate materials to a suction intake hose connected to a bulk transfer apparatus according to a preferred embodiment of the invention is provided. A body structure 7 of the nozzle 100 comprises a connecting mechanism 3 for connecting to an end portion of the suction intake hose (not shown) of the bulk transfer apparatus. The intake hose is connected using, for example, mating connectors, a screw mechanism, a clamp mechanism, or a tight fit between the intake hose and a tube portion of the connecting mechanism 3. A support mechanism such as, for example, wheel spindle assembly 4 is mechanically connected to the body structure 7 for movably supporting the nozzle. A hood 1 is mounted to a front portion of the body structure 7. The hood 1 comprises an opening 3A which is connected via a duct to the connecting mechanism 3 which is placed at a rear portion of the body structure 7. A particulate materials transport mechanism 2 is placed in front of the body structure 7 and is covered at least partially by the hood 1. The particulate materials transport mechanism 2 is movable mounted to the hood 1 (as shown in FIG. 1a) or, alternatively, mounted to the front portion of the body structure 7 using a suitable holding mechanism such as, for example, a cantilever structure. The particulate materials transport mechanism 2 comprises a movable mechanical structure such as, for example, an auger, for mechanically transporting the particulate materials into an airstream generated by suction through the suction intake hose. For example, the particulate materials transport mechanism 2 transports the particulate materials to an area in immediate proximity to the opening 3A. The hood 1 guides the airstream with the airborne particulate materials towards the opening 3A in the hood 1. The particulate materials transport mechanism 2 is rotatably mounted to the hood 1 using mounts known in the art such as, for example, various types of bearings. The particulate materials transport mechanism 2 is driven using a drive mechanism such as, for example, electric motor 15A and belt drive 15B comprising a belt and pulleys mounted to the electric motor 15A and the particulate materials transport mechanism 2 outside the hood 1.

The body structure 7, the connecting mechanism 3, the hood 1, and the auger are preferably made of a metal such as, for example, steel or aluminum. Of course other materials such as, for example, plastic materials or carbon fiber materials are also employable.

As illustrated in FIG. 1a, the particulate materials transport mechanism 2 preferably comprises an auger rotatable mounted to the hood 1 and oriented substantially horizontal with a left hand portion and a right hand portion each transporting the particulate materials towards the center, i.e. in front of the opening 3A. Employment of the particulate materials transport mechanism 2 increases the amount of particulate materials rendered airborne into the airstream and, therefore, improves the rate of transfer of the particulate material, in particular when suction is weak. The problem of weak suction is frequently encountered in agriculture when a long intake hose is needed or the hose becomes fully or partially clogged or filled.

Preferably, the support mechanism comprises two independently rotatable wheel spindle assemblies 4 with a first wheel spindle assembly 4 being mounted to a left hand side of the body structure 7 and a second wheel spindle assembly 4 being mounted to a right hand side of the body structure 7. The wheel spindle assemblies 4 are rotatably mounted to the body structure 7 using mounts known in the art such as, for example, various types of bearings. Further preferably, the wheel spindle assemblies 4 are mounted to a rear portion of the body structure 7. In the preferred embodiment, illustrated in Figures la and lb, a first drive mechanism and a second drive mechanism are employed for driving the first wheel and the second wheel, respectively. The first drive mechanism and the second drive mechanism are capable of driving the first wheel and the second wheel differently. For example, the first drive mechanism and the second drive mechanism are capable of simultaneously driving the first wheel in either a forward or rearward direction and the second wheel in either a forward or rearward direction. The first drive mechanism and the second drive mechanism comprise, for example, preferably variable speed electric motors 8 and 9 in concert with belt drives 6 and 10, respectively. The belt drives 6 and 10 each comprise a belt, a pulley mounted to the electric motor and a pulley mounted to the wheel spindle assembly. Preferably, each belt drive comprises a protective cover covering the pulleys and the belt.

Alternatively, pneumatic or hydraulic motors are employed. Further alternatively, chain drives, shaft drives or direct drives are used instead of the belt drives 6 and 10. In a further alternative embodiment of the present invention, an arrangement of one or more belts may be provided mounted on various diameter pulleys to provide the wheels with operator variable speed in a manner known to a person skilled in the art.

The capability of simultaneously driving one wheel forward and the other rearward substantially increases the maneuverability of the nozzle 100 by enabling turning of the nozzle 100 around a substantially vertically oriented axis placed between the two wheels 4. Increased maneuverability is advantageous when the nozzle 100 is used in confined spaces which are frequently encountered in storage facilities.

In the preferred embodiment the nozzle 100 comprises a handle 5 mounted to the body structure 7 in proximity to a plane 19 through the center of the first wheel 4 and the center of the second wheel 4 and oriented substantially vertical, as illustrated in FIG. 1c. This placement of the handle 5 substantially simplifies handling of the nozzle by an operator by slightly pushing down the handle 5 for lifting the hood 1 off the ground and driving the nozzle using controls 11 disposed on switch mount 12. For example, a left hand control is used for controlling the left hand drive and a right hand control is used for controlling the right hand drive. Further controls are optionally placed on the switch mount such as, for example, a control for controlling the particulate materials transport mechanism 2 and a control for remotely controlling the bulk transfer apparatus.

Handling of the nozzle 100 is further simplified by placing the connecting mechanism 3 in proximity to the plane 19 between the first wheel 4 and the second wheel 4, in order to minimize movement of the intake hose during turning of the nozzle.

Optionally, the first drive mechanism and the second drive mechanism are omitted and the support mechanism comprises only the two independently rotatable wheels 4. The nozzle is then manually moved by an operator using the handle 5.

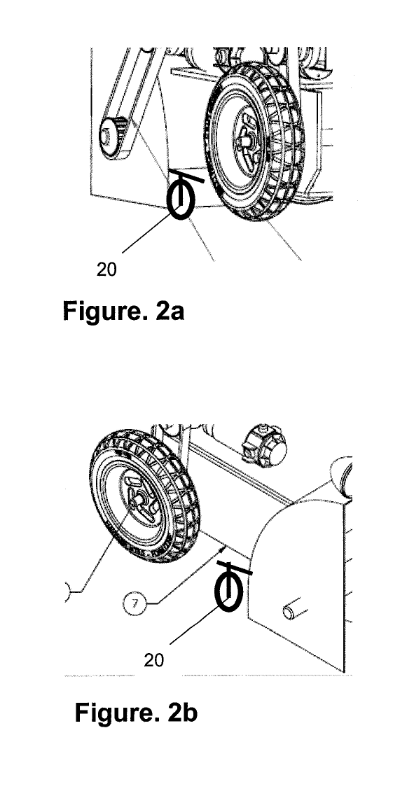

Further optionally, the nozzle 100 comprises a left hand side caster 20 and a right hand side caster 20 mounted, for example, to the hood 1, as illustrated in FIGS. 2a and 2b, or, alternatively, to the front portion of the body structure 7.

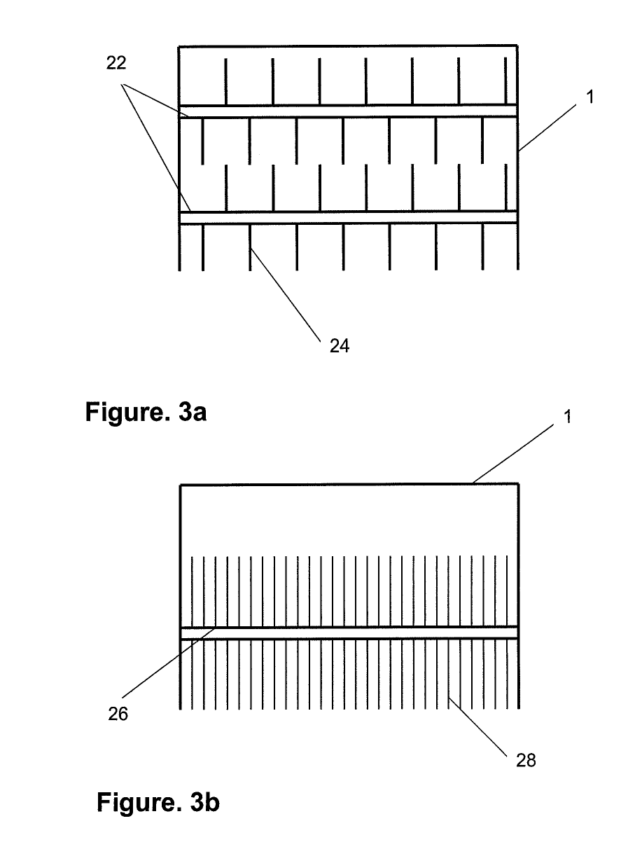

In alternative embodiments, the movable mechanical structure of the particulate materials transport mechanism 2 comprises, for example, one or more rotatably mounted cylinders having rods or bristles, made of, for example, metal or plastic material, protruding there from, as illustrated in FIGS. 3a and 3b. In a further alternative embodiment of the present invention, drag chain conveyors (not shown) are connected to the front of the nozzle to draw particulate material into the airstream of the nozzle.

The nozzle 100 is, for example, electrically operated with the power being provided, for example, via an electric power cable attached to the intake hose.

Optionally, the nozzle 100 comprises headlights 14 mounted, for example, to a top front portion of the hood 1, as illustrated in FIG. 1a, facilitating use of the nozzle in sparse lighting conditions.

Further optionally, the nozzle 100 comprises a sensor or camera 13 mounted, for example, to the handle 5. The sensor or camera 13 are useful, for example, for remotely sensing the intake of the particulate materials and/or for sensing a dust concentration in the air surrounding the nozzle, thus, increasing safety by, for example, warning an operator when there is an explosive dust concentration in the air.

In a further embodiment 200 the nozzle is remotely operable by providing a remote control mechanism 30 for remotely controlling the first and the second drive mechanism. For example, a remotely located operator is provided with video images from the camera 13 displayed on a monitor (not shown) and moves the nozzle 200 by using, for example, a joystick providing control commands to the nozzle via cable 32. Optionally, the particulate materials transport mechanism 2 is also remotely controlled using remote control mechanism 30. Alternatively, wireless transmission is employed.

In one embodiment of the present invention, in place of wheels, preferably rubberized tracks (not shown) are provided to support and guide the nozzle.

The present invention has been described herein with regard to preferred embodiments. However, it will be obvious to persons skilled in the art that a number of variations and modifications can be made without departing from the scope of the invention as described herein.

A full set of the pending claims for this application, including any amendments thereto, follows below:

1. A nozzle for providing particulate materials to a suction intake hose connected to a bulk transfer apparatus comprising:
a body structure, the body structure comprising a connecting mechanism for connecting to an end portion of the suction intake hose;
a support mechanism mechanically connected to the body structure for movably supporting the nozzle;
a particulate materials transport mechanism placed in front of the body structure, the particulate materials transport mechanism comprising a movable mechanical structure for mechanically transporting the particulate materials into an airstream generated by suction through the suction intake hose; and,
a hood mounted to a front portion of the body structure for guiding the airstream towards an opening in fluid communication with the connecting mechanism.

2. A nozzle for providing particulate materials to a suction intake hose connected to a bulk transfer apparatus as defined in claim 1 wherein the particulate materials transport mechanism transports the particulate materials to an area in immediate proximity to the opening in fluid communication with the connecting mechanism.

3. A nozzle for providing particulate materials to a suction intake hose connected to a bulk transfer apparatus as defined in claim 1 wherein the particulate materials transport mechanism comprises at least an auger.

4. A nozzle for providing particulate materials to a suction intake hose connected to a bulk transfer apparatus as defined in claim 1 wherein the connecting mechanism is designed such that the suction intake hose is oriented substantially horizontal when connected thereto.

5. A nozzle for providing particulate materials to a suction intake hose connected to a bulk transfer apparatus as defined in claim 1 wherein the support mechanism comprises two independently rotatable wheels with a first wheel being mounted to a left hand side of the body structure and a second wheel being mounted to a right hand side of the body structure.

6. A nozzle for providing particulate materials to a suction intake hose connected to a bulk transfer apparatus as defined in claim 5 comprising a handle mounted to the body structure in proximity to a plane through the center of the first wheel and the center of the second wheel and oriented substantially vertical.

7. A nozzle for providing particulate materials to a suction intake hose connected to a bulk transfer apparatus as defined in claim 6 wherein the connecting mechanism is placed such that the end portion of the suction intake hose is oriented substantially horizontal when connected thereto and wherein the connecting mechanism is placed in proximity to the plane between the first wheel and the second wheel.

8. A nozzle for providing particulate materials to a suction intake hose connected to a bulk transfer apparatus as defined in claim 7 wherein the first wheel and the second wheel are mounted to a rear portion of the body structure.

9. A nozzle for providing particulate materials to a suction intake hose connected to a bulk transfer apparatus as defined in claim 8 comprising two casters for movably supporting the nozzle.

10. A nozzle for providing particulate materials to a suction intake hose connected to a bulk transfer apparatus as defined in claim 5 comprising a first drive mechanism and a second drive mechanism for driving the first wheel and the second wheel, respectively, wherein the first drive mechanism and the second drive mechanism are capable of driving the first wheel and the second wheel differently.

11. A nozzle for providing particulate materials to a suction intake hose connected to a bulk transfer apparatus as defined in claim 10 wherein the first drive mechanism and the second drive mechanism are capable of simultaneously driving the first wheel in a forward direction and the second wheel in a rearward direction.

12. A nozzle for providing particulate materials to a suction intake hose connected to a bulk transfer apparatus as defined in claim 10 comprising a remote control mechanism for providing a control signal to the first drive mechanism and the second drive mechanism in a remotely operated fashion.
